(19) United States
(12) Patent Application Publication
(10) Pub. No.: US 2007/0040912 A1
(43) Pub. Date: Feb. 22, 2007

(54) Portable prompter for video cameras

(76) Inventor: Kirk A. Singer, Angola, IN (US)

Correspondence Address: Donald W. Meeker, 924 East Ocean Front #E, Newport Beach, CA, 92661, US

(21) Appl. No.: 11/206,331

(22) Filed: Aug. 17, 2005

(51) Int. Cl. H04N 5/225

(52) U.S. Cl. 348/207.99

(57) ABSTRACT

A rotatable cylindrical drum on a bracket attaches to a video camera. The drum has a script sheet attached around the face and is rotatable by a knob or a motor with a remote control. Bent top and bottom edges of the script sheet fold into spaced slots running lengthwise on the drum or under spaced straps to hold it in place. It can be mounted on a tripod with or without a video camera or in a handheld fashion.

### BACKGROUND OF THE INVENTION

1. Field of the Invention

The present invention relates to camera prompters and in particular to a portable prompter attachable to a video camera which is of a rugged construction adapted for offsite locations with no outside power requirements.

2. Description of the Prior Art

In videography, with talent talking into the camera it is highly efficient to keep the number of takes low to provide a prompter for the talent to read while speaking into the camera. For a natural look and ease of use, the prompter should provide the script to read in a position very close to the camera so that the individual on camera appears to be looking into the camera.

Studio prompters for talent on camera are often complex and fragile and utilize computers and mirrored configurations. These prompters have power requirements, set-up requirements, and handling requirements which do not lend themselves to use in offsite locations with portable video cameras.

U.S. Pat. No. 5,386,227, issued Jan. 31, 1995 to Zeper, provides a light-weight inexpensive portable prompter for video cameras which presents a moving textual script that can be read directly by a person in front of the camera while he is being videotaped. The prompter comprises a script-housing secured to a mounting plate which can be easily attached to the video camera, simultaneously and automatically aligning the script-housing adjacent to and under the lens of the camera with no part of said prompter within the viewing angle of said camera lens.

U.S. Pat. No. 2,981,144, issued Apr. 25, 1961 to DeFrenes, puts forth a prompting system self-contained in a unit which, in one embodiment, is supplied with an endless strip upon which there is applied the written matter. The prompting system is unattached to a camera, and can be supported by an operator using one or both hands on the device's pistol-grip.

U.S. Pat. No. 2,635,373, issued Apr. 21, 1953 to Barkau, concerns a television prompting apparatus comprising a rectangular casing having a sight opening in the front face thereof past which strip material containing intelligence is adapted to be positively moved in either direction, either continuously or intermittently. The strip material engages over teeth on a roller mounted within the casing, the roller adapted to be driven through a friction clutch. Opposite ends of the strip material are detachable secured in any preferred manner to a pair of rolls which are removably supported in the casing.

U.S. Pat. No. 2,837,294, issued Jun. 3, 1958 to Jacobs, relates to a prompting apparatus for speakers and performers wherein the script is continuously presented to the speaker's view at a desired rate and in a location not apparent to the general audience. The apparatus comprises a pair of rotatable reels carrying a script roll of semi-transparent or transparent paper, the said paper, as it travels between the reels, being passed in front of a light source which illuminates the paper and any images imprinted thereon.

U.S. Pat. No. 2,926,559, issued Mar. 1, 1960 to Oppenheimer, illustrates a prompting apparatus for cameras including box, cabinet, or other enclosure, suitably attached to a supporting bracket affixed to the camera frame. The cabinet has a front opening and an aligned rear opening that are disposed in advance of the camera lens. A plane mirror is disposed in the compartment of the cabinet in a vertical position and at a substantial angle to the axis of the lens, reflecting an object, which may have words or lines that are to be read, to the eyes of the person in front of the camera who is to read the lines or words.

U.S. Pat. No. 3,972,603, issued Aug. 3, 1976 to Lubinec, discloses an automatic prompter that uses a script written on a paper-supply roll that is fed across a reading region and coiled in a takeup roll, and a motor drives the feed mechanism in pace with the speaker reading the script. A microphone picks up the speaker's speech, and electronic circuitry amplifies the speech and detects the portion of the speech that exceeds a threshold. Switching circuitry energizes the motor whenever the speech is above the threshold and de-energizes the motor whenever the speech is not above the threshold. The drive train, including the motor and the feed roller, has mechanical inertia that cooperates with the switching circuitry so that the motor increases speed during energization up to a maximum limit and decreases speed after de-energization to provide an average speed as a function of the portion of the total time of a given interval that the energization occurs.

U.S. Pat. No. 5,477,282, issued Dec. 19, 1995 to Moore, describes a personal use, low cost, portable speech prompter which is light in weight and small in size. The speech prompter includes a support frame on which is mounted a light box with a horizontal translucent top wall. A transparent film with a speech printed thereon is slidably mounted, upside down, on the light box top wall. An image of the speech printed on the transparent film is reflected upwardly to a see-through view screen which reflects the speech image rearwardly along a line of sight between a speaker and the see-through view screen.

U.S. Pat. No. 5,790,194, issued Aug. 4, 1998 to Shimamura, claims a TV camera prompter system wherein an indicator provided thereon with a crystal panel is detachably secured to a grip portion of a main body of an Electronic News Gathering camera through a support arm, and the crystal panel is positioned around an Electronic News Gathering lens. With this arrangement, a news caster can give a news comment and the like while directly watching a picture image of a broadcasting script, which is displayed by the crystal panel. In this prompter, a half mirror can be dispensed with, so that the prompter can be rendered lighter in weight and easily portable.

U.S. Pat. No. 6,717,619, issued Apr. 6, 2004 to Wasada, shows a prompter system for a television broadcasting station, wherein a television camera is attached to a mount plate which is attached to a panhead, and a prompter body is detachably attached to the mount plate. When detaching the prompter body from the panhead, the prompter body itself is detached from the mount plate without detaching the television camera from the mount plate.

What is needed is a rugged, easy-to-use, low or no power requirement lightweight prompter for use with and attachable to a portable video camera or tripod on offsite locations that can be operated by the video camera operator to roll script sheets on standard letter, legal or continuous fold paper for a person or persons in front of the camera to read from the script sheets.

### SUMMARY OF THE INVENTION

An object of the present invention is to provide a hand turned drum video prompter which uses regular paper having a construction that is rugged, easy-to-use, low or no power requirement lightweight prompter for use with and attachable to a portable video camera on offsite locations that can be operated by the video camera operator.

A related object of the present invention is to provide a manually turned or small motor turned drum with an attached paper script that it is very simple to operate by turning so that it can be operated by the camera operator.

Another related object of the present invention is to provide a portable video prompter that it is fabricated with a hollow drum that turns on brackets attachable to a hand-held video camera which is very lightweight and rugged, making it very functional as a field prompter to fill a real need for production personnel videotaping on-camera talent on location outside of a studio setting.

A further object of the present invention is to provide mounting adaptors so that it can be operated on a tripod mounted underneath a camera, on a separate tripod from the one holding the camera, or in a hand-held fashion attached to a camera but without the use of a tripod at all.

One more object of the present invention is to provide a rotatable hollow drum with appropriately spaced paper retaining elements to hold differently sized paper so that scripting for use with the present invention can be prepared either by inkjet or laser printing on letter, legal or fanfold paper using any common word processing program, including a computer's wordpad program, or the script can simply be created in a hand-written fashion with a pen or marker on any of the above-mentioned paper formats.

Still another object of the present invention is to provide a simple hollow drum rotatable on an attaching bracket for a portable script prompter so that it will be a less expensive alternative to other teleprompter devices on the market.

In brief, a hollow drum approximately four inches in diameter and almost ten inches long pivots on a bracket which mounts to a video camera and may be mounted on a tripod with or without the camera. Longitudinal slots or other paper holding means are positioned at, locations around the drum spaced apart to hold several different sizes of paper to wrap around the drum with exposed writing on the outside of the paper so that turning the drum by hand or a small motor enables a person being videotaped on the camera to read the writing on the drum as a prompting means for speaking into the camera.

This device is meant for shorter scripts used in location shooting. It will also be invaluable for high school and college or university TV production classes, TV news crews when a reporter needs script cues, and for small and mid-size video production companies which until now could not afford simple yet functional video prompting capabilities.

The video talent prompter of the present invention can be motor driven, with the forward, reverse and speed variations controlled with a wired or wireless remote controller.

A video script can be secured to the drum of the video talent prompter of the present invention via attached scripts straps (3 plastic straps about ⅜ inch in width, running perpendicular to the drum end caps, located in the same position on the drum as the script drum slots) in lieu of drum slots.

In addition to 8½ by 11 (letter size) or 8½ by 14 (legal size) script application, continuous or fanfold paper may be also be used for longer script applications, allowing for any length of scripting.

Also a part of the video talent prompter of the present invention is a tripod mounting filler plate, an aluminum plate with two holes integrated to accommodate the mounting of a camcorder onto the quick release shoe of a tripod. The purpose of this filler plate is as follows. The attachment of the video talent prompter onto a tripod requires a longer bolt to attach the quick release to the bottom of a camcorder. The camera operator can simply remove the video talent prompter, insert the tripod mounting filler plate and reattach the camera to the tripod without having to change out the bolt which connects the tripod to the video camera.

An advantage of the present invention is that it is hand operated and requires no electricity.

Advantages of the present invention over prior art devices include that the present invention requires no breakable reflective mirrors or one-way glass, laptop or desktop computers or a bulky support frame.

Another advantage of the present invention is that it is very simple to operate so that it can be operated by the camera operator.

A further advantage of the present invention is that it is very lightweight and rugged, making it very functional as a field prompter to fill a real need for production personnel videotaping on-camera talent on location outside of a studio setting. This device is meant for shorter scripts used in location shooting. It will also be invaluable for high school and college or university TV production classes, TV news crews when a reporter needs script cues, and for small and mid-size video production companies which until now could not afford simple yet functional video prompting capabilities.

Further advantages of the present invention is that it can be operated on a tripod mounted underneath a camera, on a separate tripod from the one holding the camera, or in a hand-held fashion attached to a camera but without the use of a tripod at all.

One more advantage of the present invention is that scripting for use with the present invention can be prepared either by inkjet or laser printing on letter, legal or fanfold paper using any common word processing program, including a computer's wordpad program, or the script can simply be created in a hand-written fashion with a pen or marker on any of the above-mentioned paper formats.

Still another advantage of the present invention is that it will be a less expensive alternative to other teleprompter devices on the market.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of the components of the portable video prompter of the present invention aligned for mounting on a hand-held video camera;

FIG. 2 is a perspective view of the portable video prompter of FIG. 1 mounted on a tripod mounted video camera;

FIG. 2A is a perspective view of the script support hollow drum of FIG. 2 with a script aligned for mounting thereon;

FIG. 3 is a front elevational view of the script support of the portable video prompter of the present invention for rotating the script;

FIG. 4 is cross-sectional view of the script support of FIG. 3 showing the angular relationship of the slot script holding elements on the script support;

FIG. 5A is a cross-sectional view of the script support of FIG. 3 showing two different sizes of script sheets mounted on the script support with the folded edges of the script sheets inserted in the slot script holding elements of the script support with a fanfold continuous sheet script aligned for mounting on the script support;

FIG. 5B is a cross-sectional view of the script support of the present invention showing two different sizes of script sheets mounted on the script support with the folded edges of the script sheets inserted under externally mounted strip script holding elements on the script support with a fanfold continuous sheet script aligned for mounting on the script support;

FIG. 5C is a cross-sectional view of the script support of FIG. 3 showing two different sizes of script sheets mounted on the script support with the folded edges of the script sheets inserted in angled slot script holding elements of the script support with a fanfold continuous sheet script aligned for mounting on the script support.

### BEST MODE FOR CARRYING OUT THE INVENTION

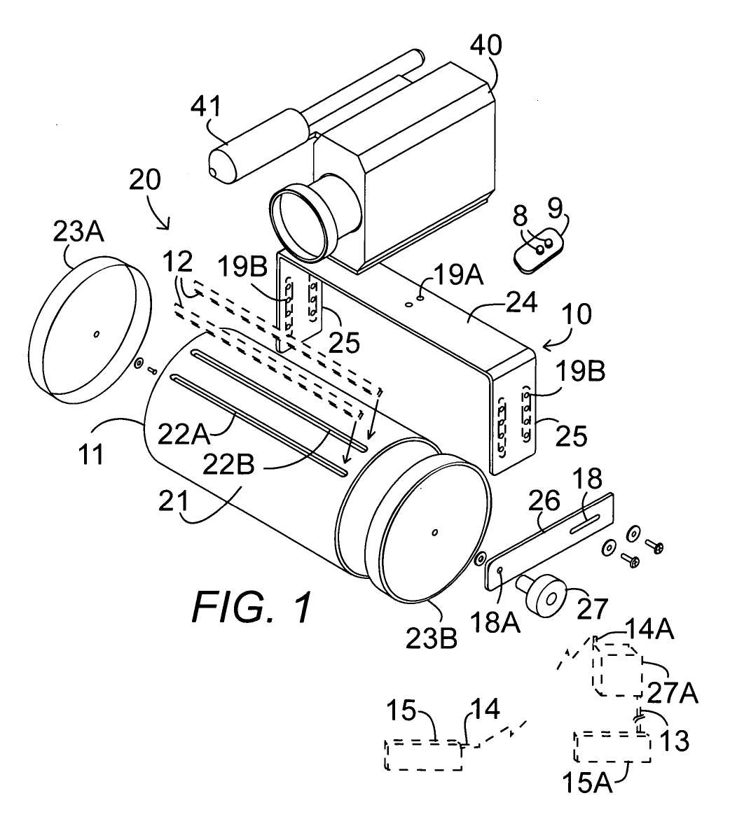

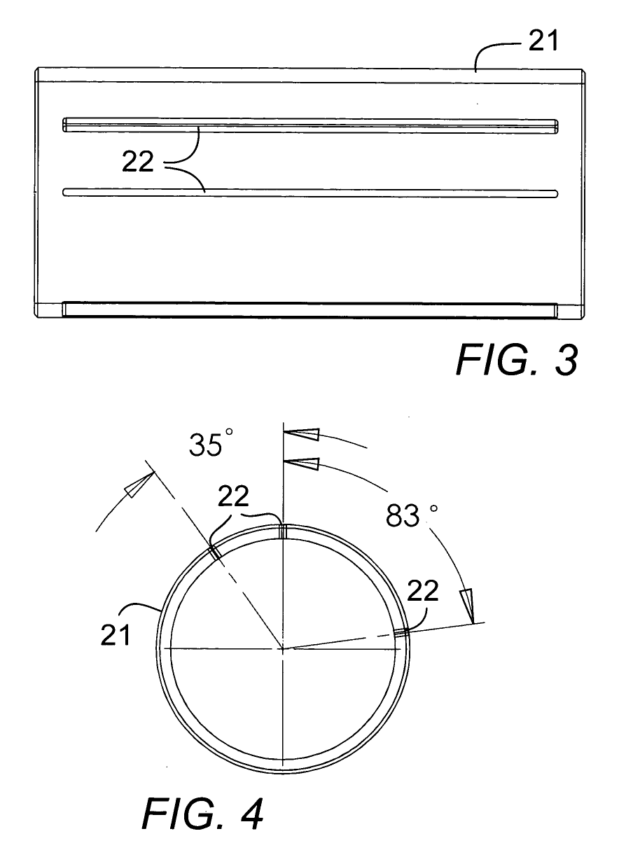

In FIGS. 1-5, a portable prompter device 20 for use with a video camera 40 and microphone 41 comprises a bracket 10 and rotating script support 11 mounted rotatably on the bracket.

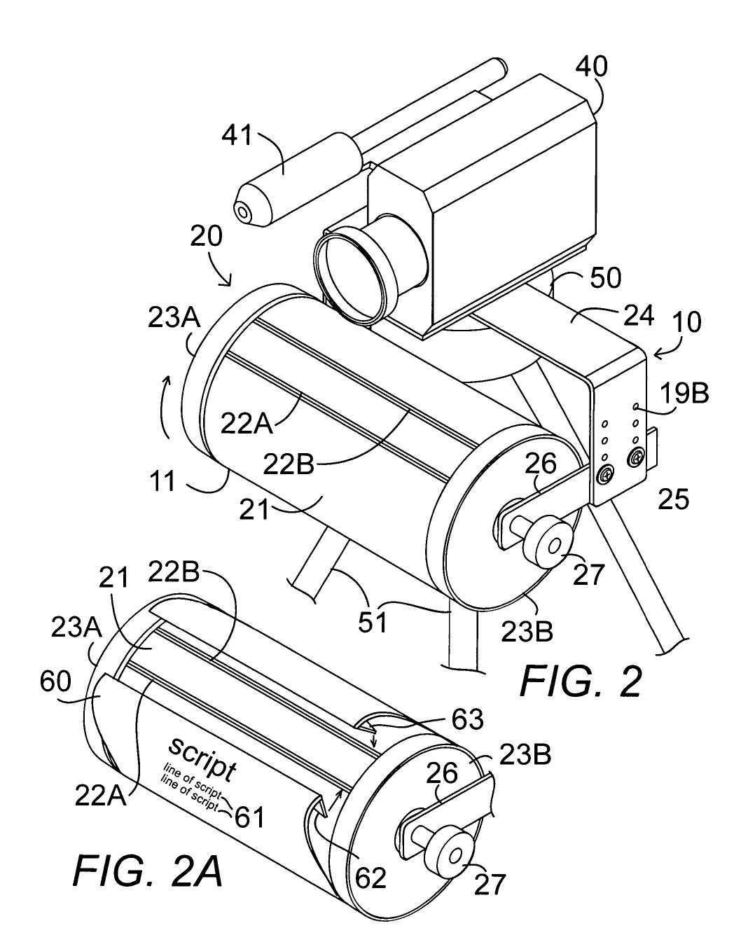

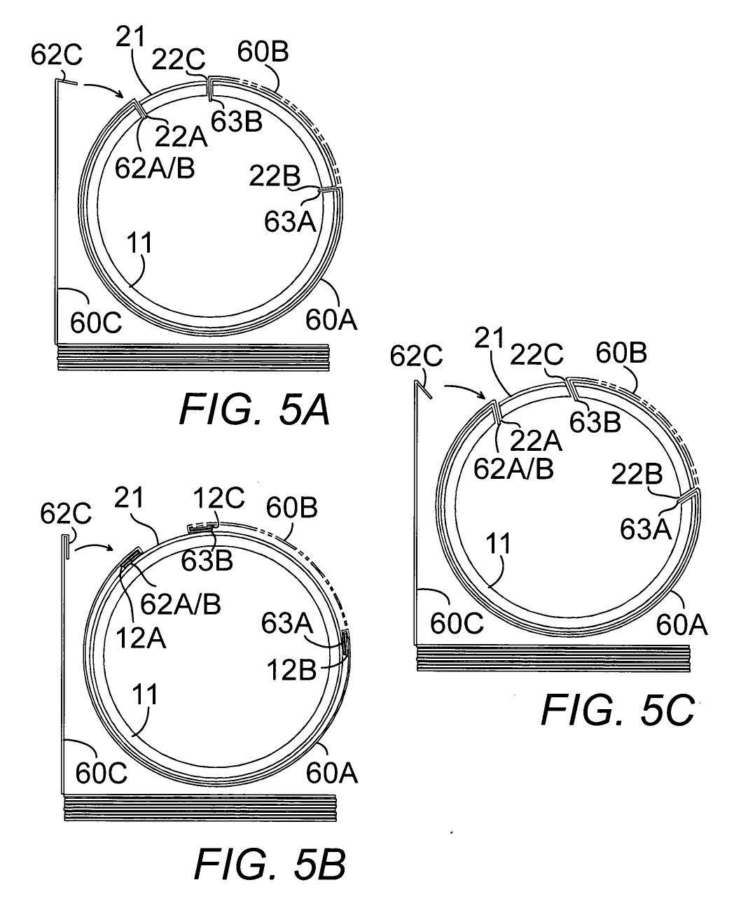

In FIGS. 1 and 2, the rotatable script support 11 comprises a hollow cylindrical drum with a convex outer display face 21 and two flat ends 23A in the form of end caps. A bracket 10 is used for mounting the script support at each of the two flat ends so that the script support is rotatable in the bracket with the bracket attached to an external object. There is a means for rotating the script support in the bracket, such as a turning knob 27 or motor 27A which may have a remote control 15A connected by a wire 13 or a wireless remote control 15 communicating by signals from an antenna 14 on the wireless remote control 15 to an antenna 14A on the motor 27A. A series of script holding elements 22 or 12 are each positioned on the display face 21 from end to end at spaced intervals around the display face 21 so that a flat script sheet 60, as seen in FIGS. 2A, 5A and 5B, is held against the display face 21 with a top end 62 of the script sheet held by one script holding element and a bottom end 63 of the script sheet held by another of the script holding elements. The spaced intervals of the script holding means are sized for holding script sheets of a variety of lengths so that as the script support is rotated, writing on a face of the script sheet is readable by a person positioned in front of the script support while the script support is rotated to present lines 61 of script on the script support to a person reciting the lines of script into a microphone 41:

In FIGS. 1-5A, each of the script holding elements comprises a slot 22 in the display face 21 along the length of the script support from end to end, the slot having at least one edge for receiving an end of a script sheet bent over and hooked on the edge, as shown in FIG. 5A with the top script ends 62A, 62B and 62C folded over and inserted in the slot 22A and the bottom script ends 63A and 63B bent over and inserted in slots 22B and 22C. In FIG. 5C the slots 22A, 22B, and 22C are angled more sharply to assist in holding the top script ends 62A, 62B, and 62C and bottom script ends 63A and 63B. The continuous fanfold letter-size script sheet 60C attaches only at a top bent sheet end 62C and then winds repeatedly around the script support drum 11 as it turns allowing for any length of scripting.

In FIGS. 1 and 5B, each of the script holding elements may alternately comprise a strip of material 12 (shown dashed in FIG. 1), preferably a plastic strap, attached to the display face 21 along the length of the script support from end to end, the strip of script holding material receiving an end of a script sheet bent over and hooked under the strip of script holding material with the top ends of the script sheets 62A, 62B and 62C bent over one strip of script holding material 12A and the bottom ends 63A and 63B best over other strips of script holding material 12B and 12C with a letter size script sheet 60A and a legal size script sheet 60B or an international size sheet held onto the display face 21 between the top and bottom ends. The continuous fanfold letter-size script sheet 60C attaches only at a top end and then winds around the script support drum 11 as it turns allowing for any length of scripting.

The spaced intervals of the script holding means are sized for holding a script sheet of letter size 60A, legal size 60B, international size (could be the same as the letter size interval), and continuous fanfold letter-size 60C allowing for any length of scripting.

In FIG. 1, the bracket 10 comprises two arms 25 interconnected by a cross brace 24, each of the arms having a vertical series of paired openings (or a pair of vertical parallel slots shown dashed) 19B for receiving threaded connectors from a horizontal plate 26 through a slot 18 in the plate for horizontal adjustment to allow the script to be positioned in close proximity to the camera lens so that the person's eyes are looking close to the camera lens, the horizontal plate 26 vertically adjustable on the arms 25 by placement in different paired openings 19B, each horizontal plate having at least one opening 18A for rotatably receiving an element from the script support therein and the cross brace 24 comprises a detachable means for attaching the cross brace to an external object, such as an underside of a video camera 40 using threaded fasteners through top holes 19A in the cross brace 24.

In FIG. 1, a plate 9 is removably attachable to the cross brace, the plate having an adapter 8 for quick release removable attachment to a camera tripod 51. The plate 9 is a tripod mounting filler plate with standard integrated holes or openings 8 with connectors to accommodate a mounting of a camcorder 40 attached to the bracket 10 onto a quick release shoe of a tripod 51.

The device of claim 1 wherein the bracket further comprises an attaching means for securing the bracket to a video camera 40 with an associated microphone 41 so that a person positioned in front of the video camera can read the script sheet 60 on the rotatable script support 11, wherein the attaching means for securing the bracket 10 to a video camera 40 comprises at least one opening 19A in the bracket and a threaded element for removably securing the bracket 10 to a hand-held video camera 40.

In FIG. 1, the means for rotating the script support 11 may comprise at least one shaft, which could be a threaded screw or bolt shaft, rigidly secured to the script support through an end cap 23A and 23B with the shaft extending through an opening 18A in the bracket which permits rotation of the script support drum 11 and shaft relative to the bracket 26 and 10 and a knob 27 rigidly secured to an outer end of the rigid shaft for turning the shaft and the script support 11, the knob being operable by a person operating the video camera.

Alternately the means for rotating the script support 11 may comprise at least one shaft rigidly secured to the script support 11 with the shaft extending through an opening 18A in the bracket 26 which permits rotation of the shaft relative to the bracket and a motor 27A (shown dashed in FIG. 1) secured to an outer end of the rigid shaft for turning the shaft and the script support, the motor being operable by a person operating the video camera. The device may further comprise a wireless remote control 15 for operating the motor with an antenna 14 for communicating with a mating antenna 14A on the motor or a wired remote control 15A with a wire 13 connected to the motor 27A for operating the motor.

The script support 11 is preferably approximately four inches in diameter and almost ten inches long to accommodate letter, legal, and continuous fold script sheets. The drum is preferably a section of PVC pipe with metal or plastic end caps 23A and 23B and metal brackets 10 and 26.

In practice the device 20 is attached to a video camera 40 or tripod 51 and the video operator operates the turning of the script support 11 for a person or persons in front of the camera to read from the script sheet 60 while being filmed and recorded.

It is understood that the preceding description is given merely by way of illustration and not in limitation of the invention and that various modifications may be made thereto without departing from the spirit of the invention as claimed.

What is claimed is:

1. A portable prompter device for use with a video camera, the device comprising:
a rotatable script support comprising a hollow cylindrical drum with a convex outer display face and two flat ends, a bracket for mounting the script support at each of the two flat ends so that the script support is rotatable in the bracket with the bracket attached to an external object, a means for rotating the script support in the bracket, a series of script holding elements each positioned on the display face from end to end at spaced intervals around the display face so that a flat script sheet is held against the display face with a top end of the script sheet held by one script holding elements and a bottom end of the script sheet held by another of the script holding elements, the spaced intervals of the script holding means sized for holding script sheets of a variety of lengths so that as the script support is rotated, writing on a face of the script sheet is readable by a person positioned in front of the script support while the script support is rotated to present lines of script on the script support to a person reciting the lines of script into a microphone.

2. The device of claim 1 wherein the bracket comprises two arms interconnected by a cross brace, each of the arms having a vertical series of paired openings for receiving threaded connectors from a horizontal plate, the horizontal plate vertically adjustable on the arms, each horizontal plate having at least one opening for rotatably receiving an element from the script support therein and the cross brace comprises a detachable means for attaching the device to an external object.

3. The device of claim 3 further comprising a plate removably attachable to the cross brace, the plate having an adapter for removable attachment to a camera tripod.

4. The device of claim 3 wherein the plate comprises a tripod mounting filler plate having two holes integrated to accommodate a mounting of a camcorder attached to the bracket onto a quick release shoe of a tripod.

5. The device of claim 1 wherein the bracket further comprises an attaching means for securing the bracket to a video camera with an associated microphone so that a person positioned in front of the video camera can read the script sheet on the rotatable script support.

6. The device of claim 5 wherein the attaching means for securing the bracket to a video camera comprises at least one opening in the bracket and a threaded element for removably securing the bracket to a video camera.

7. The device of claim 5 wherein the means for rotating the script support comprises at least one shaft rigidly secured to the script support with the shaft extending through an opening in the bracket which permits rotation of the shaft relative to the bracket and a knob rigidly secured to an outer end of the rigid shaft for turning the shaft and the script support, the knob being operable by a person operating the video camera.

8. The device of claim 5 wherein the means for rotating the script support comprises at least one shaft rigidly secured to the script support with the shaft extending through an opening in the bracket which permits rotation of the shaft relative to the bracket and a motor secured to an outer end of the rigid shaft for turning the shaft and the script support, the motor being operable by a person operating the video camera.

9. The device of claim 8 further comprising a wireless remote control for operating the motor.

10. The device of claim 8 further comprising a wired remote control for operating the motor.

11. The device of claim 5 wherein the bracket comprises two arms interconnected by a cross brace, each of the arms having a vertical series of paired openings for receiving threaded connectors from a horizontal plate, the horizontal plate vertically adjustable on the arms, each horizontal plate having at least one opening for rotatably receiving an element from the script support therein and the cross brace comprises a detachable means for attaching the cross brace to an underside of a video camera.

12. The device of claim 5 wherein the bracket comprises two arms interconnected by a cross brace, each of the arms having a pair of vertical parallel slots for receiving threaded connectors from a horizontal plate, the horizontal plate vertically adjustable on the arms, each horizontal plate having at least one opening for rotatably receiving an element from the script support therein and the cross brace comprises a detachable means for attaching the cross brace to an underside of a video camera.

13. The device of claim 1 wherein each of the script holding elements comprises a slot in the display face along the length of the script support from end to end, the slot having at least one edge for receiving an end of a script sheet bent over and hooked on the edge.

14. The device of claim 13 wherein the slot is angled perpendicular to the display face.

15. The device of claim 13 wherein the slot is at an acute angle to the display face.

16. The device of claim 1 wherein each of the script holding elements comprises a strip of script holding material attached to the display face along the length of the script support from end to end, the strip of script holding material receiving an end of a script sheet bent over and hooked under the strip of script holding material.

17. The device of claim 1 wherein the spaced intervals of the script holding means sized for holding a script sheet of a size taken from the list of sheet sizes including letter size, legal size, international size, and continuous or fanfold allowing for any length of scripting.

18. The device of claim 1 wherein the script support is approximately four inches in diameter and almost ten inches long.
